(19) United States
(12) Patent Application Publication
(10) Pub. No.: US 2026/0229545 A1
(43) Pub. Date: Aug. 6, 2026

(54) POWER STORAGE DEVICE

(71) Applicant: TOYOTA JIDODHA KABUSHIKI KAISHA, Toyota-shi (JP)

(72) Inventor: Shuichi NISHIDA, Toyota-shi (JP)

(73) Assignee: TOYOTA JIDODHA KABUSHIKI KAISHA, Toyota-shi (JP)

(21) Appl. No.: 19/389,129

(22) Filed: Nov. 14, 2025

(30) Foreign Application Priority Data
Jan. 31, 2025 (JP) 2025-015367

(51) Int. Cl. H01M 4/66; H01M 4/75

(52) U.S. Cl. CPC H01M 4/667; H01M 4/661; H01M 4/75

(57) ABSTRACT

A power storage device includes: a first metal layer provided at a portion of a first surface of a first current collecting foil where a first active material layer is not provided; and a second metal layer provided at a portion of a second surface of a second current collecting foil where a second active material layer is not provided. The first metal layer and the second metal layer are disposed at positions where the first metal layer and the second metal layer overlap each other in a thickness direction of an electrode foil. A thermal expansion coefficient of the first current collecting foil is greater than a thermal expansion coefficient of the second current collecting foil. A thermal expansion coefficient of the first metal layer is smaller than a thermal expansion coefficient of the second metal layer.

### CROSS-REFERENCE TO RELATED APPLICATION

This application claims priority to Japanese Patent Application No. 2025-015367 filed on January 31, 2025. The disclosure of the above-identified application, including the specification, drawings, and claims, is incorporated by reference herein in its entirety.

### BACKGROUND

### 1. Technical Field

The present disclosure relates to a power storage device.

### 2. Description of Related Art

Japanese Unexamined Patent Application Publication No. 2005-317468 (JP 2005-317468 A) discloses a bipolar electrode in which a surface of a cathode current collector where a cathode active material layer is not formed and a surface of an anode current collector where an anode active material layer is not formed are connected to face each other.

### SUMMARY

In the bipolar electrode disclosed in JP 2005-317468 A, when a current flows and the cathode current collector and the anode current collector generate heat, warping occurs in thin portions where the cathode active material layer and the anode active material layer are not formed due to a difference in thermal expansion coefficient between the cathode current collector and the anode current collector.

The present disclosure has been made in view of the above issue, and has an object to provide a power storage device in which the occurrence of warping can be suppressed in an electrode foil including a first current collecting foil where a first active material layer is provided and a second current collecting foil where a second active material layer is provided.

To address the above issue and achieve the object, the power storage device according to the present disclosure is a power storage device including an electrode foil that includes a first current collecting foil where a first active material layer is provided on a first surface and a second current collecting foil where a second active material layer is provided on a second surface, and in which a third surface opposite to the first surface of the first current collecting foil and a fourth surface opposite to the second surface of the second current collecting foil are connected to face each other. The power storage device includes: a first metal layer provided at a portion of the first surface of the first current collecting foil where the first active material layer is not provided; and a second metal layer provided at a portion of the second surface of the second current collecting foil where the second active material layer is not provided. The first metal layer and the second metal layer are disposed at positions where the first metal layer and the second metal layer overlap each other in a thickness direction of the electrode foil. A thermal expansion coefficient of the first current collecting foil is greater than a thermal expansion coefficient of the second current collecting foil. A thermal expansion coefficient of the first metal layer is smaller than a thermal expansion coefficient of the second metal layer.

Thus, in the power storage device according to the present disclosure, the occurrence of warping can be suppressed in the electrode foil including the first current collecting foil where the first active material layer is provided and the second current collecting foil where the second active material layer is provided.

In the above, the first current collecting foil and the second metal layer may be made of the same type of metal, and the second current collecting foil and the first metal layer may be made of the same type of metal.

Thus, the metal materials used for the first current collecting foil and the second current collecting foil can be reused for the first metal layer and the second metal layer, thereby simplifying the configuration of the electrode foil.

In the above, the portion of the first surface where the first metal layer is provided and the first active material layer is not provided may be a peripheral edge of the first surface, and the portion of the second surface where the second metal layer is provided and the second active material layer is not provided may be a peripheral edge of the second surface.

Thus, buckling can be suppressed at the peripheral edge of the electrode foil due to the difference in thermal expansion coefficient between the first current collecting foil and the second current collecting foil.

The power storage device according to the present disclosure has an effect that the occurrence of warping can be suppressed in the electrode foil including the first current collecting foil where the first active material layer is provided and the second current collecting foil where the second active material layer is provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a sectional view showing a schematic configuration of a main part of a power storage device according to an embodiment;

FIG. 2 is a top view showing the schematic configuration of the power storage device according to the embodiment; and

FIG. 3 is a sectional view showing another example of the schematic configuration of the main part of the power storage device according to the embodiment.

### DETAILED DESCRIPTION OF EMBODIMENTS

A power storage device according to an embodiment of the present disclosure will be described below. The present disclosure is not limited to the present embodiment.

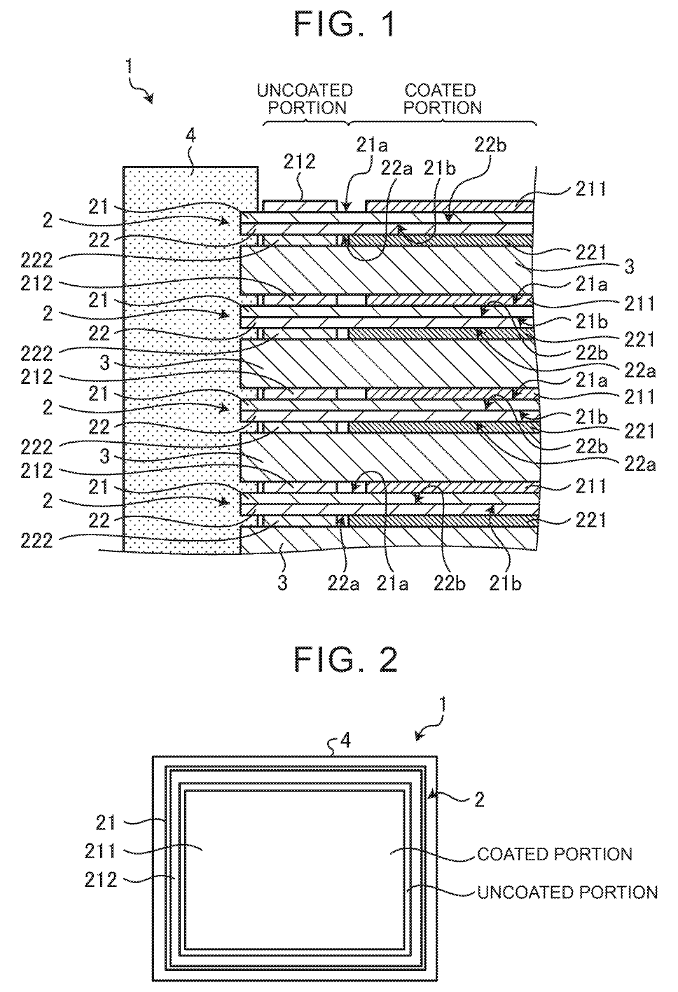

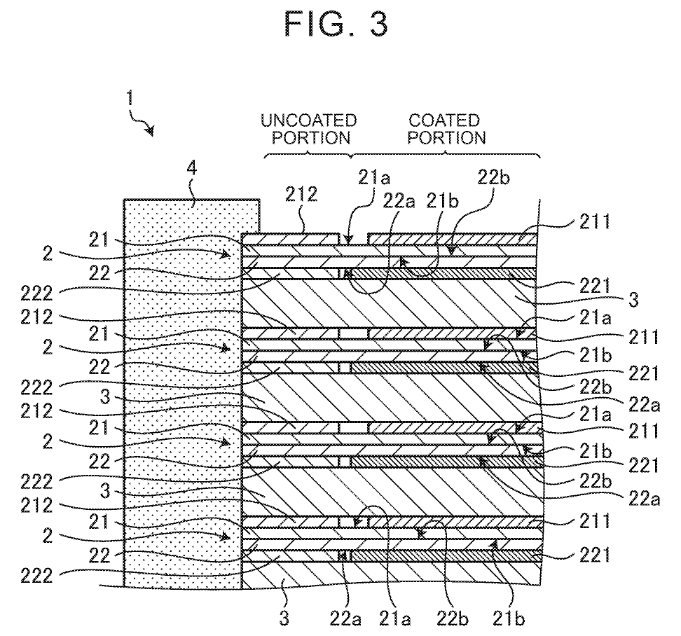

FIG. 1 is a sectional view showing a schematic configuration of a main part of a power storage device 1 according to the embodiment. FIG. 2 is a top view showing the schematic configuration of the power storage device 1 according to the embodiment. FIG. 3 is a sectional view showing another example of the schematic configuration of the main part of the power storage device 1 according to the embodiment.

The power storage device 1 according to the embodiment includes a plurality of bipolar electrode foils 2, a plurality of separators 3, and an end face fusing portion 4. The bipolar electrode foils 2 and the separators 3 each have a flat plate shape and are laminated alternately. Their outer ends (peripheral edges) are embedded in and fused with the end face fusing portion 4 made of resin.

The bipolar electrode foil 2 is a laminated electrode foil formed by bonding together a flat plate-shaped cathode current collecting foil 21 that is a first current collecting foil, and a flat plate-shaped anode current collecting foil 22 that is a second current collecting foil. As shown in FIG. 2, on a front surface 21a that is a first surface of the cathode current collecting foil 21, a coated portion that is coated with a cathode active material that is a first active material is present on an inner side in a plane direction, and an uncoated portion that is not coated with the cathode active material is present on an outer side (peripheral edge of the front surface 21a) in the plane direction relative to the coated portion. The coated portion on the front surface 21a of the cathode current collecting foil 21 is coated with the cathode active material to form a cathode active material layer 211 that is a first active material layer. A first metal layer 212 made of the same type of metal as that of the anode current collecting foil 22 is formed on the uncoated portion on the front surface 21a of the cathode current collecting foil 21. The thickness of the first metal layer 212 is, for example, several tens of micrometers to several hundreds of micrometers, and is preferably equal to or smaller than the thickness of the cathode active material layer (first active material layer) 211.

On a front surface 22a that is a second surface of the anode current collecting foil 22, a coated portion that is coated with an anode active material is present on an inner side in a plane direction, and an uncoated portion that is not coated with the anode active material is present on an outer side (peripheral edge of the front surface 22a) in the plane direction relative to the coated portion. The coated portion on the front surface 22a of the anode current collecting foil 22 is coated with the anode active material to form an anode active material layer 221 that is a second active material layer. A second metal layer 222 made of the same type of metal as that of the cathode current collecting foil 21 is formed on the uncoated portion on the front surface 22a of the anode current collecting foil 22. The thickness of the second metal layer 222 is, for example, several tens of micrometers to several hundreds of micrometers, and is preferably equal to or smaller than the thickness of the anode active material layer (second active material layer) 221.

In the bipolar electrode foil 2, a back surface 21b that is a third surface opposite to the front surface 21a of the cathode current collecting foil 21 and a back surface 22b that is a fourth surface opposite to the front surface 22a of the anode current collecting foil 22 are connected to face each other. In the bipolar electrode foil 2, one of the front surface 21a of the cathode current collecting foil 21 and the front surface 22a of the anode current collecting foil 22 is the front surface of the bipolar electrode foil 2, and the other is the back surface of the bipolar electrode foil 2. The coated portion of the cathode current collecting foil 21 and the coated portion of the anode current collecting foil 22 are the coated portions of the bipolar electrode foil 2. The uncoated portion of the cathode current collecting foil 21 and the uncoated portion of the anode current collecting foil 22 are the uncoated portions of the bipolar electrode foil 2.

As shown in FIG. 1, the first metal layer 212 of the cathode current collecting foil 21 and the second metal layer 222 of the anode current collecting foil 22 are disposed at positions where they overlap each other in a thickness direction of the bipolar electrode foil 2. The outer end faces of the first metal layer 212 of the cathode current collecting foil 21 and the second metal layer 222 of the anode current collecting foil 22 in the plane direction are in contact with the side faces of the end face fusing portion 4 as shown in FIG. 1. As shown in FIG. 3, the outer end of the first metal layer 212 in the plane direction and the outer end of the second metal layer 222 in the plane direction may be embedded in the end face fusing portion 4.

The cathode current collecting foil 21 and the anode current collecting foil 22 are made of different metal materials such that the thermal expansion coefficient of the cathode current collecting foil 21 is greater than the thermal expansion coefficient of the anode current collecting foil 22. For example, the cathode current collecting foil 21 is made of aluminum, and the anode current collecting foil 22 is made of copper. For reference, the thermal expansion coefficient of aluminum is 23.1 × 10⁻⁶/°C, and the thermal expansion coefficient of copper is 16.5 × 10⁻⁶/°C, meaning that the thermal expansion coefficient of aluminum is 1.4 times greater than that of copper.

The first metal layer 212 and the anode current collecting foil 22 are made of the same metal material (type of metal), and the second metal layer 222 and the cathode current collecting foil 21 are made of the same metal material (type of metal). Thus, the metal materials used for the cathode current collecting foil 21 and the anode current collecting foil 22 can be reused for the first metal layer 212 and the second metal layer 222, thereby simplifying the configuration of the bipolar electrode foil 2. For example, in the power storage device 1 according to the embodiment, the first metal layer 212 is formed by attaching the same metal foil (copper foil) as the anode current collecting foil 22 (copper foil) to the uncoated portion on the front surface 21a of the cathode current collecting foil 21 (aluminum foil) using a conductive adhesive. In the power storage device 1 according to the embodiment, the second metal layer 222 is formed by attaching the same metal foil (aluminum foil) as the cathode current collecting foil 21 (aluminum foil) to the uncoated portion on the front surface 22a of the anode current collecting foil 22 (copper foil) using a conductive adhesive. Therefore, the thermal expansion coefficient of the first metal layer 212 is smaller than the thermal expansion coefficient of the second metal layer 222.

In the bipolar electrode foil 2, when a current flows and the cathode current collecting foil 21 and the anode current collecting foil 22 generate heat, a difference in thermal expansion coefficient between the cathode current collecting foil 21 and the anode current collecting foil 22 causes, in the uncoated portion, an upward convex warping stress that causes the cathode current collecting foil 21 side to become convex. When heat is applied to the first metal layer 212 and the second metal layer 222 via the cathode current collecting foil 21 and the anode current collecting foil 22, a difference in thermal expansion coefficient between the first metal layer 212 and the second metal layer 222 causes, in the uncoated portion, a downward convex warping stress that causes the second metal layer 222 side to become convex. As a result, in the bipolar electrode foil 2, the upward convex warping stress is canceled out by the downward convex warping stress, thereby suppressing warping of the uncoated portion. Therefore, in the power storage device 1 according to the embodiment, the occurrence of warping can be suppressed in the bipolar electrode foil 2 including the cathode current collecting foil 21 where the cathode active material layer 211 is provided and the anode current collecting foil 22 where the anode active material layer 221 is provided. In particular, in the power storage device 1 according to the embodiment, buckling caused by warping can be suppressed in the uncoated portion (peripheral edge) of the bipolar electrode foil 2 including the cathode current collecting foil 21 where the cathode active material layer 211 is provided at the coated portion and the anode current collecting foil 22 where the anode active material layer 221 is provided at the coated portion.

What is claimed is:

1. A power storage device including an electrode foil that includes a first current collecting foil where a first active material layer is provided on a first surface and a second current collecting foil where a second active material layer is provided on a second surface, and in which a third surface opposite to the first surface of the first current collecting foil and a fourth surface opposite to the second surface of the second current collecting foil are connected to face each other, the power storage device comprising:
a first metal layer provided at a portion of the first surface of the first current collecting foil where the first active material layer is not provided; and
a second metal layer provided at a portion of the second surface of the second current collecting foil where the second active material layer is not provided, wherein
the first metal layer and the second metal layer are disposed at positions where the first metal layer and the second metal layer overlap each other in a thickness direction of the electrode foil,
a thermal expansion coefficient of the first current collecting foil is greater than a thermal expansion coefficient of the second current collecting foil, and
a thermal expansion coefficient of the first metal layer is smaller than a thermal expansion coefficient of the second metal layer.

2. The power storage device according to claim 1, wherein:
the first current collecting foil and the second metal layer are made of the same type of metal; and
the second current collecting foil and the first metal layer are made of the same type of metal.

3. The power storage device according to claim 1, wherein:
the portion of the first surface where the first metal layer is provided and the first active material layer is not provided is a peripheral edge of the first surface; and
the portion of the second surface where the second metal layer is provided and the second active material layer is not provided is a peripheral edge of the second surface.
